(19) United States
(12) Patent Application Publication
(10) Pub. No.: US 2017/0280899 A1
(43) Pub. Date: Oct. 5, 2017

(54) HYBRID SKEWER

(71) Applicant: EDIBLE ARRANGEMENTS, LLC, Wallingford, CT (US)

(72) Inventors: Cynthia Mockler, North Haven, CT (US); Tariq Farid, North Haven, CT (US)

(21) Appl. No.: 15/476,846

(22) Filed: Mar. 31, 2017

Related U.S. Application Data
(60) Provisional application No. 62/316,738, filed on Apr. 1, 2016.

(51) Int. Cl. A47F 7/00; A47J 43/18; A47J 43/28

(52) U.S. Cl. CPC A47F 7/0071; A47J 43/28; A47J 43/18; A47J 37/04

(57) ABSTRACT

Disclosed herein is a hybrid skewer comprising an elongated rod that in turn comprises a handle portion and a skewer portion. The skewer portion and handle portion are separated by a circular shoulder element. The skewer portion comprises a plurality of raised longitudinal fins running the length of the skewer portion and the fins are of sufficient size to engage a food or non-food item and prevent the item from rotating about the axis of the skewer portion. The handle portion comprises a surface pattern, the surface pattern covering at least a portion of the circumference of the handle portion. The handle portion terminates in a tapered tip for facilitating the insertion of the handle portion into a support platform or base.

### CROSS REFERENCE TO RELATED APPLICATION

The present invention claims priority to U.S. Provisional Application No. 62/316,738, filed on Apr. 1, 2016 and entitled “Hybrid Skewer,” which is hereby incorporated herein in its entirety.

### RELATED FIELD

The present invention is directed to a novel skewer, also called hybrid skewer, as herein described.

### BACKGROUND

Skewers are often used to secure fruit and other food or non-food items in a decorative display or arrangement. For example, Edible Arrangements LLC, a market leader in the creation and sale of fresh fruit arrangements, utilizes skewers in a variety of manners to hold and display cut and whole fruit, as well as other food or non-food items including chocolate, in order to provide a variety of aesthetically pleasing food arrangements.

Representative fruit, provided whole or cut up into parts, that may be held in arrangements with skewers include pineapples, strawberries, honeydew, cantaloupe, grapes, bananas, among other varieties of fruit. Many examples of the types of fruit arrangements that can be created using skewers and shapes of cut fruit within the arrangements are shown on Edible Arrangement's website at www.ediblearrangements.com, which is incorporated herein by reference in its entirety.

An exemplary type of skewer that may be employed to hold and display fruit (and other food and non-food items) is shown and described in U.S. Pat. No. 7,052,059, which is hereby incorporated herein by reference in its entirety. U.S. Pat. No. 7,052,059 also identifies various older types of skewers, including skewers invented as early as in the 19th century.

Although older types of skewers may adequately hold food items in a display or during a cooking operation, such skewers have their limitations. For instance, a food item lodged on a skewer ultimately may slide down the length of a skewer. The food item may ultimately fall off the skewer. Or the food item may ultimately rotate around the skewer. These problems arise at different times and under different circumstances. For example, some skewers create a relatively large hole in the food item as the skewer pierces into it, which in turn minimizes the skewer's ability to properly maintain the food item at a fixed location. The food item may then slide down the shaft of the skewer (sometimes slowly, sometimes quickly). Other times, the food item will rotate about the skewer's shaft, generally due to the effect of gravity on the food item. Food items that have moisture, which includes fruit, tend to soften over time, which exacerbates the problems mentioned above.

What is needed in the field are skewers with better design that would overcome these defects.

### SUMMARY

Disclosed herein is a skewer having an elongated rod-like configuration. The elongated rod has a handle portion and a skewer portion. The handle portion and the skewer portion are separated by a raised protrusion. In some embodiments, the skewer portion comprises a plurality of raised longitudinal fins running the length of the skewer portion. The fins are of sufficient size to engage a food or non-food item and prevent the item from rotating about the axis of the skewer portion. In some embodiments, the handle portion comprises a surface pattern, the surface pattern covering at least a portion of the circumference of the handle portion. In some embodiments, the handle portion terminates in a tapered tip for facilitating the insertion of the handle portion into a support platform or base.

In some embodiments, the skewer portion further comprises one or more rupture points located in a groove between two adjacent longitudinal fins.

In some embodiments, the skewer portion further comprises two to six rupture points.

In some embodiments, the skewer portion comprises three to six longitudinal fins.

In some embodiments, the skewer portion comprises at a sharpened tip at one end to allow easy insertion of the tip into the food or non-food item.

In some embodiments, the skewer portion has a length that is shorter than that of the handle portion.

In some embodiments, the handle portion encompasses about 60-70% of the length of the elongated rod.

In some embodiments, the raised protrusion comprises a raised circular shoulder, the raised circular shoulder serving to prevent the item from sliding down the length of the skewer.

In some embodiments, the region of the handle portion connecting to the raised protrusion has a dimension that is smaller than that of the region of the skewer portion connecting to the raised protrusion.

In some embodiments, the surface pattern covers approximately the entire circumference of the handle portion.

In some embodiments, the skewer is manufactured from plastic, wood, metal, or a combination thereof.

In some embodiments, a cross section of the skewer portion has a cross-shaped pattern, Y-shaped pattern, or a star-shaped pattern.

As disclosed herein, any embodiments can be combined in any applicable ways.

### BRIEF DESCRIPTION OF THE DRAWINGS

Those of skill in the art will understand that the drawings, described below, are for illustrative purposes only. The drawings are not intended to limit the scope of the present teachings in any way.

FIG. 1 illustrates an exemplary embodiments of a hybrid skewer in perspective view.

FIG. 2 illustrates an exemplary embodiments of a hybrid skewer in front view.

FIG. 3 illustrates an exemplary embodiment of the skewer or top portion of a hybrid skewer in side view.

FIG. 4 illustrates an exemplary embodiment of the skewer portion of a hybrid skewer in cross-sectional view.

FIG. 5 illustrates an exemplary embodiment of the skewer portion of a hybrid skewer showing a rupture point.

FIG. 6 illustrates an exemplary embodiment of a hybrid skewer showing a circular shoulder.

FIG. 7 illustrates an exemplary embodiment of the bottom or handle portion of a hybrid skewer showing surface pattern on the handle.

FIG. 8 illustrates an exemplary embodiment of the handle portion of a hybrid skewer showing a tapered point.

FIG. 9 illustrates an exemplary embodiment of the handle portion of a hybrid skewer showing pattern on the handle portion.

FIG. 10 illustrates an exemplary embodiment of a hybrid skewer.

FIG. 11 illustrates an exemplary embodiment of a hybrid skewer showing a circular shoulder.

### DESCRIPTION OF THE INVENTION

Accordingly, the hybrid skewer of the present invention, shown and explained in detail below, includes structural features that prevent, or at least minimize, problems associated with existing skewers, including the above-mentioned undesirable movement or rotation of food items while being held on the skewer. Moreover, the hybrid skewer of the present invention includes a novel grip-section that has improved gripping by a gloved hand as compared to existing skewers. The hybrid skewer's novel grip-section also advantageously prevents, or at least minimizes, stress or sore spots on hands that ordinarily would result from repeated handling and use of ordinary skewers. The novel grip-section further advantageously is securely held within a base made of Styrofoam or other appropriate material.

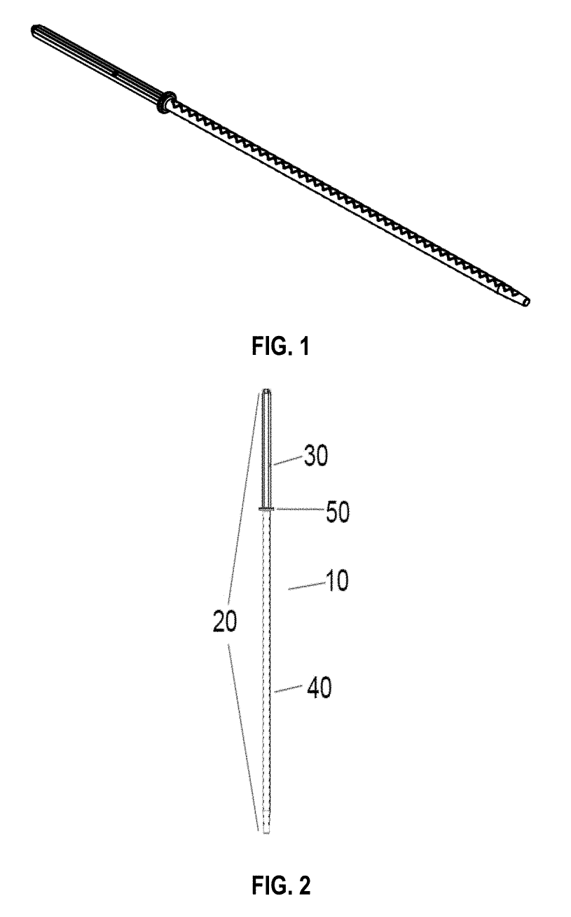

The hybrid skewer of the present invention is shown in an overview in FIG. 1.

FIG. 2 provides another view of the hybrid skewer of the present invention and includes reference numbers to refer to various portions of the hybrid skewer. In particular, the hybrid skewer also is referred to herein as skewer 10, and skewer 10 includes a shaft 20 that extends along its entire length. Shaft 20 includes two sections: a top skewer portion 30 (also called skewer portion 30); and a bottom handle portion 40 (also called handle portion 40). A circular shoulder 50 is interposed between top skewer portion 30 and bottom handle portion 40. For example, skewer portion 30 starts from circular shoulder 50 and ends at a sharpened tip. The tip has a smaller dimension than other parts of skewer portion 30 and is sharpened for easy insertion of tip into a food or non-food item.

As will be described in further detail herein, top skewer portion 30 is employed to hold fruit and other food items. For convenience, references to fruit, fruit portions and the like also include non-fruit items, such as chocolate and other items that may be held by the hybrid skewer of the present invention. Bottom handle portion 40 serves a handle during handling of the skewer and also serves as an anchor for the skewer once inserted into a suitable base, as further discussed below.

The shaft 20 may be formed from one uniform piece of material and shaped into different portions, e.g., top skewer portion 30 and bottom handle portion 40. Alternatively, the shaft 20 may be formed from different pieces and assembled into one piece.

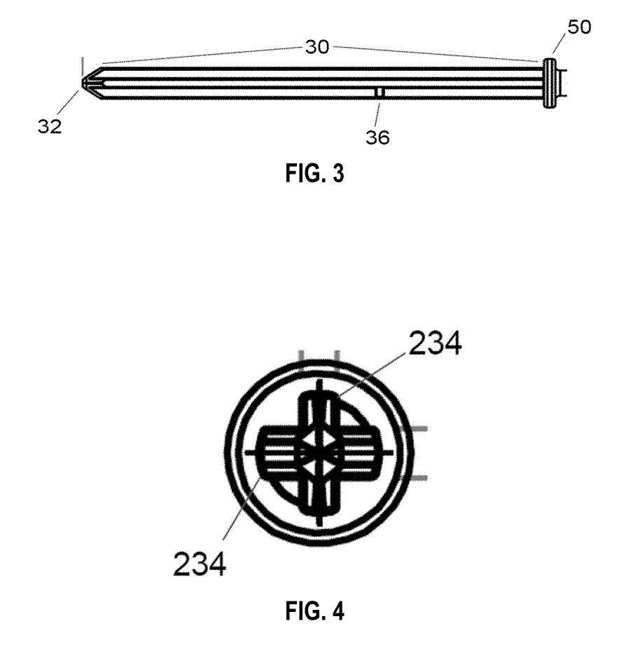

Referring to FIG. 3, top skewer portion 30 begins at one end of shaft 20, at tip 32. As illustrated in FIG. 3, from tip 32, top skewer portion 30 then proceeds along shaft 20 until its terminus at circular shoulder 50.

FIG. 4 illustrates a close-up, cross-sectional view of top skewer portion 30, as viewed facing tip 32.

The cross-section of the top skewer portion 30 is uniquely formed in the shape of a “+,” which includes longitudinal fins 234. Fins 234 are formed perpendicularly to one another, and provide four different contact points. A plurality of fins can be formed, including but not limited to two or more fins, three or more fins, four or more fins, five or more fins, six or more fins, or eight or more fins. Referring to FIG. 3, tip 32 illustrates the tapering of the “+” shape formed by four fins. Additional cross-section may have a Y shape or a projecting star burst shape with various number arms.

Referring again to FIG. 4, top skewer portion 30 includes a rupture point 36. In certain embodiments, multiple rupture points 36 are included. The rupture point 36 may be located at any suitable distance between tip 32 and circular shoulder 50. As discussed further below, the rupture points allow the skewer to break easily in order to prevent injury to a person or damage to an object. In some embodiments, the rupture points are located in the grooves between any two adjacent longitudinal fins.

In an embodiment, as illustrated above in FIG. 3, rupture point 36 is located closer to circular shoulder 50 than to tip 32. In another embodiment, rupture point 36 is located approximately one and one-quarter (1.25) inches from the tip 32, although other distances are contemplated by the invention.

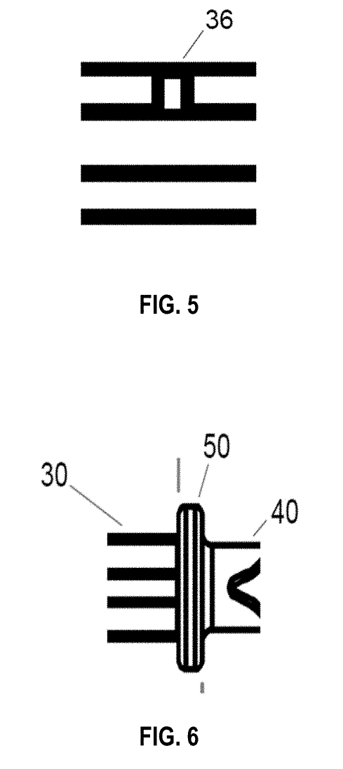

FIG. 5 is a zoomed-in view of the rupture point 36 as illustrated in FIG. 3. For example, a cross section of rupture point 36 can be a square, a circle, a rectangle, a triangle, an oval, any other shape, or combinations thereof.

In accordance with the invention, two rupture points are located along the length of top skewer portion 30, and the circular shoulder 50 is formed to operate as a third rupture point.

Referring to FIG. 6, at the terminus of top skewer portion 30, at the point farthest from tip 32, shaft 20 becomes bottom portion 40. As discussed above, bottom portion 40 may be formed from the same piece as top skewer portion 30. Alternatively, bottom portion 40 and top skewer portion 30 may be formed from separate pieces and may be attached by any suitable means.

Bottom portion 40 may begin on a side of circular shoulder 50, opposite the side of top skewer portion 30, with a first terminus adjacent to circular shoulder 50, and a second terminus at tapered tip 42.

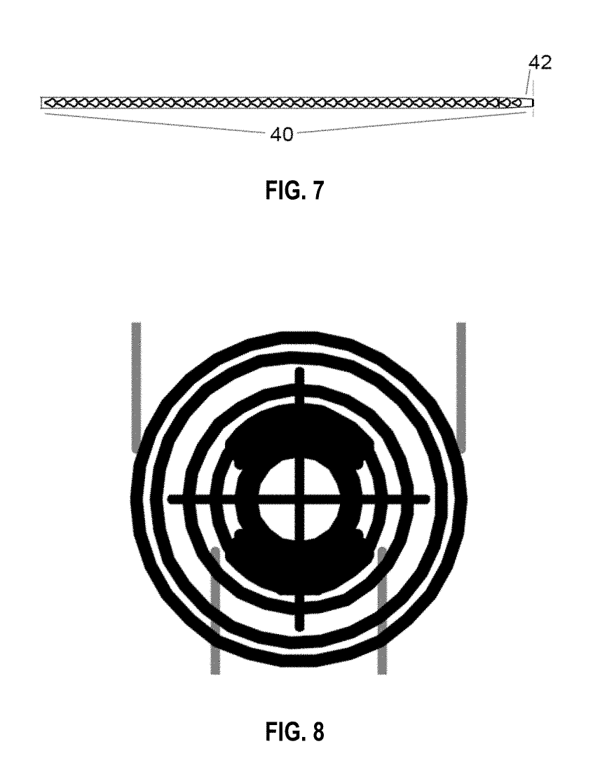

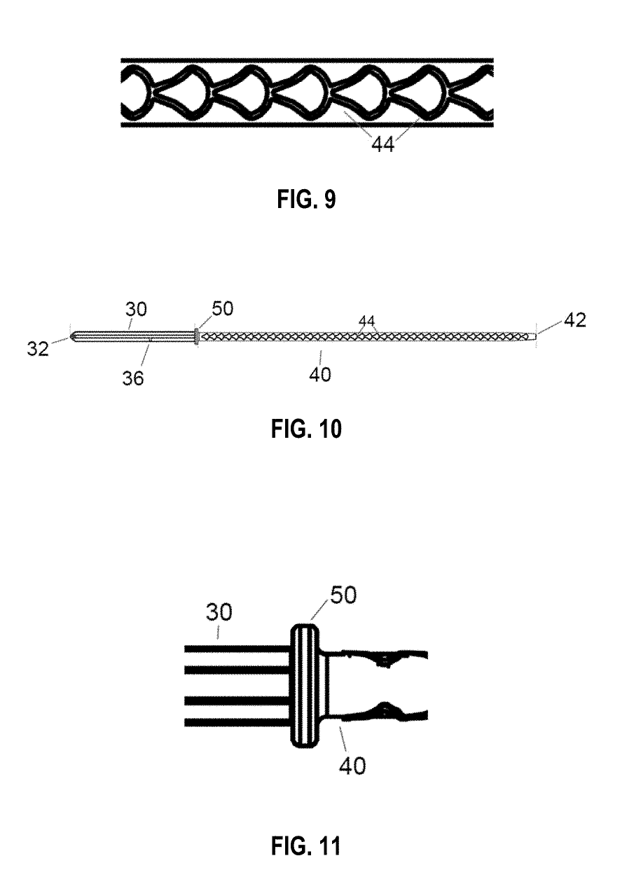

FIG. 7 illustrates an exemplary embodiment of the entirety of bottom portion 40.

Referring to FIG. 6, the first terminus of bottom portion 40 is adjacent to circular shoulder 50, which divides shaft 20 between top skewer portion 30 and bottom portion 40.

In accordance with the invention, and as illustrated above in FIGS. 1-2, bottom portion 40 encompasses about 60-70% of the length of the shaft 20, although additional proportions are contemplated by the invention. In some embodiments, bottom portion 40 encompasses about 10-90% of the length of the shaft 20. In some embodiments, bottom portion 40 encompasses about 30-80% of the length of the shaft 20. In some embodiments, bottom portion 40 encompasses about 40-70% of the length of the shaft 20. In some embodiments, bottom portion 40 encompasses about 50-80% of the length of the shaft 20. In some embodiments, bottom portion 40 encompasses about 50-70% of the length of the shaft 20. In some embodiments, bottom portion 40 is longer than top skewer portion 30. In some embodiments, bottom portion 40 is shorter than top skewer portion 30.

Referring again to FIG. 7, proceeding along the length of bottom portion 40 from the circular shoulder 50, bottom portion 40 tapers slightly as it moves farther away from circular shoulder 50 and towards tapered portion 42. At the end of bottom portion 40 nearest to tapered tip 42, bottom portion 40 tapers more significantly.

Tapered tip 42 is formed around a hollow internal core, which is shown in FIG. 8 from a bottom perspective.

Bottom portion 40 includes pattern 44. Pattern 44 may cover a part of the bottom portion 40. In certain embodiments, pattern 44 may cover the entirety of bottom portion 40.

Surface pattern 44 is etched along the length of the bottom portion 40. Pattern 44 is preferably formed in a scalloped pattern entirely around the diameter of bottom the shaft 20. Alternatively and/or additionally, the surface pattern 44 may be formed as chains of linked circle, oral, or other geometric shape. Alternatively and/or additionally, the surface pattern 44 may be formed as waves, dots, or grids. Surface pattern 44 provides a smooth surface for gripping by fingers. Surface pattern 44 provides frictions while maintaining comfort.

Circular shoulder 50 divides shaft 20 between top skewer portion 30 and bottom portion 40. Circular shoulder 50 is wider than the remainder of shaft 20, as illustrated in FIG. 6 above. It should be noted that shoulder 50 may be formed from the same piece as bottom portion 40 and/or top skewer portion 30. In certain embodiments, circular shoulder 50 may be formed from a separate piece and attached to bottom 40 and top skewer portion 30.

Illustrated in FIG. 10 is an exemplary location of circular shoulder 50, disposed between the top skewer portion 30 and bottom portion 40.

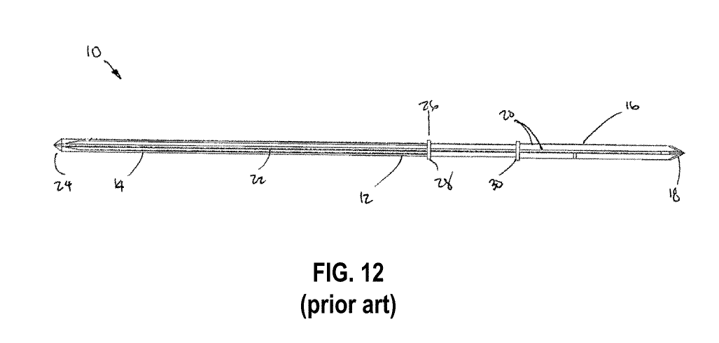

A zoomed-in view, illustrating the relative size and width of circular shoulder 50, and its division between top skewer portion 30 and bottom portion 40, is illustrated in FIG. 11. As depicted, top skewer portion 30 has a dimension larger than that of bottom portion 40. This facilitates easier insertion of bottom portion 40 into a foam base or any other type of display support material.

Referring again to FIG. 10, circular shoulder 50 is located approximately two inches from the tip 32 of the shaft 20, and is the terminus of the top skewer portion 30. Additionally, the location of circular shoulder 50 is approximately one-third of the way down shaft 20 away from tip 32. At the other end, circular shoulder 50 is approximately two-thirds of the way down shaft 20 from tapered tip 42.

It should be noted, however, that additional measurements are contemplated by the invention. For example, circular shoulder 50 may be located at the midpoint of shaft 20.

Circular shoulder 50 is generally circular in shape and encircles shaft 20 in its entirety. As discussed above, circular shoulder 50 may be formed as an additional rupture point.

The division of shaft 20 into separate portions (e.g., top portion 30 and bottom portion 40) allows the inventive skewer to properly be inserted into an object, such as fruit. The fruit is inserted onto the shaft 20 over the edge of top skewer portion 30, at tip 32.

Once the fruit is skewered, the top skewer portion 30 prevents the fruit from rotating about the longitudinal axis of the skewer 10. Additionally, top skewer portion 30, and more specifically, the “+” shape of top skewer portion 30, prevents the fruit from sliding down the length of the skewer 10 into bottom portion 40.

Referring to FIG. 3, top skewer portion 30 is inserted into a food item by being pushed into the item at tip 32. Tip 32 pierces the edge or flesh of the food item and inserts itself into the food item.

By providing four different contact points, fins 234, in their perpendicular arrangement as shown in FIGS. 3-4, pushes into the innards of a food item, without forming a large hole. In an exemplary embodiment, the hole formed by fins 234 is approximately equal in diameter to the edge of the fins themselves. As a result fins 234 grip the inside of the hole and do not allow formation of an extra space.

The fins 234 are operable to engage the inside of the food item, thereby gripping fruit flesh or any other material from the inside, without increasing the hole diameter. This prevents the fruit from rotating about the axis of the skewer 10. In turn, this prevents a hole from being created in the food item, and additionally, prevents a user from twisting the item onto the skewer. Instead, the skewer must pierce, or must be pushed into, the food item.

As fruit or an object is slid onto skewer 10 at tip 32, the fruit proceeds down the length of the top portion 30, toward the bottom portion 40.

Bottom portion 40 is designed to be easily inserted into a material or display for holding an arrangement together. For example, skewer 10, in top skewer portion 30, may hold an arrangement of fruits. Bottom portion 40 may be designed to be inserted into Styrofoam, or any other suitable material, and hold the arrangement upright. In an embodiment, it should be noted that the bottom portion 40 does not come into contact with fruit or other foods, and instead serves to anchor the skewer.

The bottom portion 40 is formed such that the skewer 10 can be comfortably held and gripped while the fruit is being placed onto the skewer 10. Additionally, the bottom portion 40 is formed so as to be anchored in a display, without moving or falling, and without causing the fruit or other objects to move about the longitudinal axis of skewer 10.

Surface pattern 44 on bottom portion 40 provides for an optimal gripping surface for a hand to hold the skewer 10 while assembling fruit or other items on the top skewer portion 30, so that the skewer can be maintained in place. The uniquely formed scallop surface pattern 44 prevents sore spots from forming on hands. As disclosed here, the terms “surface pattern” and “pattern” are used interchangeably.

In an exemplary embodiment, the formation of the scalloped surface pattern 44 provides optimal gripping for a gloved hand preparing a fruit arrangement, thereby preventing sore spots from being formed on the hand. The surface pattern 44, by providing an optimal gripping surface, prevents a user from forming sore spots due to prevention of repeated slippage, and as a result, contact with shoulder 50. Moreover, the gripping provided by scalloped pattern 44 prevents significant movement of the skewer 10.

Circular shoulder 50 provides a predetermined stopping point for displayed fruit that is inserted onto top portion 30 at tip 32. Thus, circular shoulder 50, due to its increased thickness and dimension, prevents food items from sliding down shaft 20 towards bottom portion 40. This allows bottom portion 40 to provide optimal gripping and anchoring functions. Moreover, by maintaining the position of food items within top skewer portion 30, the aesthetic of the display itself is maintained.

As the fruit is skewered, shoulder 50 additionally serves to hold the food items in place, preventing them from moving about the axis of the skewer 10.

Skewer 10 as disclosed herein is advantageous over what is known in the art in many aspects. FIG. 12 depicts a skewer that is disclosed in U.S. Pat. No. 7,052,059 (the '059 Patent), which has a top or skewer portion (element 16 in FIG. 12) with fins and a bottom or handle portion (element 14 in FIG. 12). The skewer disclosed in the '059 Patent includes two shoulder-like elements (element 28 and 30 shown in FIG. 12). The shoulder elements were designed to be held by a user and to function as stoppers to prevent the skewer from going too far into either a fruit piece or a support base. However, feedback from actual users revealed that holding the skewer at the shoulder-like elements creates pain and fatigue in the fingers, especially for high-volume operation. The tighter a user holds the skewer, the more severe is the pain and discomfort. In addition, even if a user holds the skewer by the region between the two shoulder-like elements, the fingers will inevitably slide down and hit the bottom shoulder, resulting in discomfort and pain. Due to the sliding motion, the discomfort and pain can be quite significant from high volume work.

The new skewer structure is designed to specifically overcome these issues upon receiving feedback from hundreds of users. For example, one of the shoulder is removed to avoid pain and discomfort from the sliding and hitting motions. In addition, chamfer-like structure in the skewer disclosed in the '059 Patent is replaced with gripping surface pattern 44 which provides both friction and comfort. Without the bottom shoulder, fingers would no longer be hit and result in pain and discomfort. The current hybrid skewer has a configuration that provides ease and comfort to enable efficiency in high volume work.

Additionally, circular shoulder 50 advantageously also serves as a stopping point for when the skewer 10 is inserted into a material or display. Thus, the entirety of bottom portion 40 can be inserted into a material, such as Styrofoam, and the raised edges of shoulder 50 prevent the entirety of the shaft 20, including displayed food items on top skewer portion 30, from being inserted entirely into a material.

Moreover, as discussed herein, the skewer includes one or more rupture points. These rupture points allow the skewer to break easily when a sufficient force is exerted on an end of the skewer. For instance, during transportation of a fruit arrangement that includes one or more (often many) skewers in accordance with the present invention, the rupture points on each of the skewers operate as a safety feature. In particular, if the fruit arrangement is forced into an object (which can be a person), such as may happen in the case of a vehicle accident, the skewers break at their rupture points, thus preventing damaging to objects and preventing injury to persons. With the existence of rupture points, the skewers of the present invention still are sufficiently strong to hold fruit and other items in place, as discussed herein, but also such rupture points beneficially are able to break if necessary.

While the invention contemplates skewers with varying thickness levels, it should be noted that the above-discussed inventive skewer may be formed at an optimal thickness level that provides sufficient thickness for stability, which is necessary for heavier food items, such as pineapple. Additionally, the inventive skewer is formed with sufficient thinness so that it is flexible enough to bend. In contrast, known skewers are either too thick, such that they provide stability but cannot bend, or they are too thin, such that they provide flexibility but are unstable.

The skewer 10 may be formed from any suitable materials, in accordance with the invention. For example, wood, plastic, metal and any other suitable materials are contemplated by the invention.

While the present invention has been described in the context of a number of embodiments and variations thereof, it is to be understood that other expedients known to those skilled in the art may be employed without departing from the spirit of the invention.

Furthermore, while the present invention has been described with reference to top portions and bottom portions, it is to be understood that such nomenclature is for the sake of illustration and convenience, and the invention contemplates reversal of these locations.

We claim:

1. A skewer, comprising:
an elongated rod having a handle portion and a skewer portion, the handle portion and the skewer portion being separated by a raised protrusion,
wherein the skewer portion comprises a plurality of raised longitudinal fins running the length of the skewer portion, the fins being of sufficient size to engage a food or non-food item and prevent the item from rotating about the axis of the skewer portion,
wherein the handle portion comprises a surface pattern, the surface pattern covering at least a portion of the circumference of the handle portion, and
wherein the handle portion terminates in a tapered tip for facilitating the insertion of the handle portion into a support platform or base.

2. The skewer of claim 1, wherein the skewer portion further comprises one or more rupture points located in a groove between two adjacent longitudinal fins.

3. The skewer of claim 1, wherein the skewer portion further comprises two to six rupture points.

4. The skewer of claim 1, wherein the skewer portion comprises three to six longitudinal fins.

5. The skewer of claim 1, wherein the skewer portion comprises at a sharpened tip at one end to allow easy insertion of the tip into the food or non-food item.

6. The skewer of claim 1, wherein the skewer portion has a length that is shorter than that of the handle portion.

7. The skewer of claim 1, wherein handle portion encompasses about 60-70% of the length of the elongated rod.

8. The skewer of claim 1, wherein the raised protrusion comprises a raised circular shoulder, the raised circular shoulder serving to prevent the item from sliding down the length of the skewer.

9. The skewer of claim 1, wherein the region of the handle portion connecting to the raised protrusion has a dimension that is smaller than that of the region of the skewer portion connecting to the raised protrusion.

10. The skewer of claim 1, wherein the surface pattern covers approximately the entire circumference of the handle portion.

11. The skewer of claim 1, wherein the skewer is manufactured from plastic, wood, metal, or a combination thereof.

12. The skewer of claim 1, wherein a cross section of the skewer portion has a cross-shaped pattern, Y-shaped pattern, or a star-shaped pattern.
